(19) United States
(12) Patent Application Publication
(10) Pub. No.: US 2003/0225542 A1
(43) Pub. Date: Dec. 4, 2003

(54) Electronic fan capable of automatic fan speed adjustment according to ambient temperature conditions

(76) Inventors: Chang-Ming Liu, Taichung City (TW); Cheng-Hsien Chang, Taichung City (TW)

Correspondence Address: TROP PRUNER & HU, PC, 8554 KATY FREEWAY, SUITE 100, HOUSTON, TX, 77024, US

(21) Appl. No.: 10/156,425

(22) Filed: May 28, 2002

(51) Int. Cl. G06F 15/00

(52) U.S. Cl. 702/132

(57) ABSTRACT

An electric fan includes a fan unit, a temperature detector for generating a temperature output that varies in accordance with the ambient temperature, and a processor unit operable so as to control the fan unit to rotate at a selected one of preset speed settings, and further operable in an intelligent mode, wherein the processor unit determines a current selected one of the preset speed settings of the fan unit and receives the temperature output of the temperature detector so as to obtain a reference ambient temperature, and wherein the processor unit controls the fan unit to operate at a higher preset speed setting upon detection of a predetermined increase in the current ambient temperature, and at a lower preset speed setting upon detection of a predetermined decrease in the current ambient temperature.

### BACKGROUND OF THE INVENTION

1. Field of the Invention

The invention relates to an electric fan, more particularly to an electric fan capable of automatic fan speed adjustment according to ambient temperature conditions.

2. Description of the Related Art

A conventional electric fan, such as a ceiling fan, is usually provided with a manual control unit to control the fan speed. However, because the manual control unit is normally disposed at a fixed location that may be inaccessible to some people, activation of the electric fan and switching of the fan speed may be inconvenient to conduct. It has been proposed heretofore to provide a remote-controlled electric fan to overcome the aforesaid drawbacks that are associated with operation of the manual control unit. It is noted that the known remote-controlled electric fan only permits adjustment of the fan speed to any one of four preset speed settings selected by the user. As a result, after a particular speed setting has been selected, the fan motor will operate continuously at the selected fan speed. During warm nights, a high fan speed might be selected for producing a cooling effect that can help the user to fall asleep easily. However, continued high fan speed operation can eventually result in user discomfort in view of lower ambient temperatures at dawn.

### SUMMARY OF THE INVENTION

Therefore, the main object of the present invention is to provide an electric fan that can perform automatic fan speed adjustment in accordance with the detected ambient temperature to overcome the aforesaid drawbacks of the prior art.

According to the present invention, an electric fan comprises a fan unit, a temperature detector for generating a temperature output that varies in accordance with the ambient temperature, and a processor unit coupled to the fan unit and the temperature detector.

The processor unit is operable so as to control the fan unit to rotate at a selected one of preset speed settings, and is further operable in an intelligent mode, wherein the processor unit determines a current selected one of the preset speed settings of the fan unit and receives the temperature output of the temperature detector so as to obtain a reference ambient temperature, wherein the processor unit controls the fan unit to operate at another one of the preset speed settings higher than the current selected one of the present speed settings upon detection of a predetermined increase in the current ambient temperature relative to the reference ambient temperature, and wherein the processor unit controls the fan unit to operate at yet another one of the preset speed settings lower than the current selected one of the present speed settings upon detection of a predetermined decrease in the current ambient temperature relative to the reference ambient temperature.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a fan device of the preferred embodiment of an electric fan according to the present invention;

FIG. 2 is a schematic electrical circuit diagram of the fan device of FIG. 1;

FIG. 3 is a schematic electrical circuit diagram of a fan unit of the fan device of FIG. 1; and

FIG. 4 is a schematic view showing a remote controller of the preferred embodiment.

### DETAILED DESCRIPTION OF THE PREFERRED EMBODIMENT

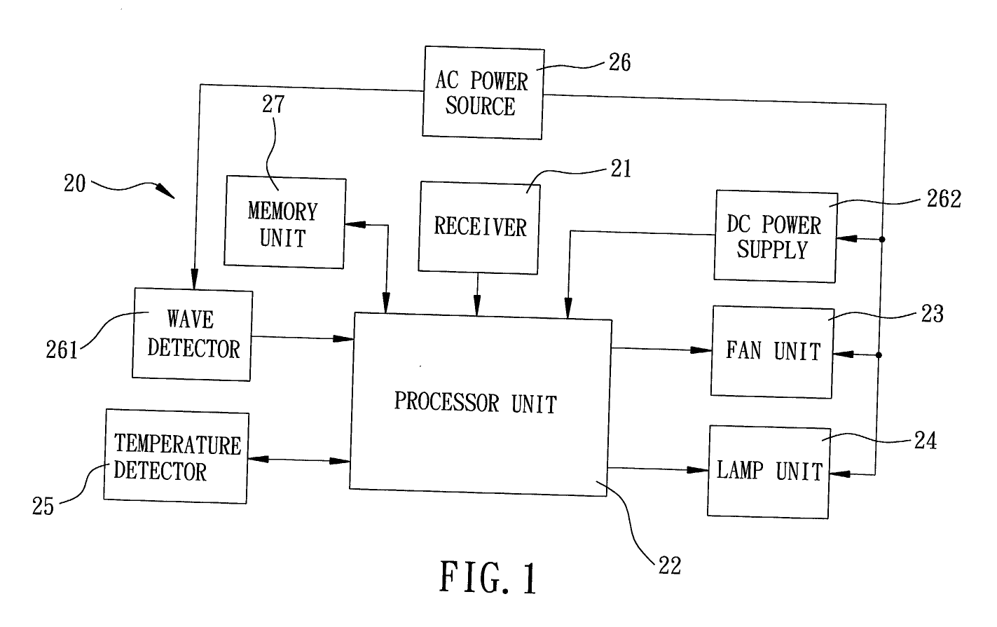

Referring to FIGS. 1 to 4, the electric fan of the present invention is shown to be embodied in a ceiling fan that includes a remote controller 10 and a fan device 20. The fan device 20 includes a receiver 21, a processor unit 22, a fan unit 23, a lamp unit 24, a temperature detector 25, a wave detector 261, a direct current (DC) power supplying circuit 262, and a memory unit 27.

The receiver 21, which is coupled to the processor unit 22, receives remote-control signals transmitted by the remote controller 10, and provides the same to the processor unit 22. The processor unit 22 is coupled to the fan unit 23, the lamp unit 24, the temperature detector 25, the wave detector 261, the DC power supplying circuit 262, and the memory unit 27. Each of the fan unit 23, the lamp unit 24, the wave detector 261 and the DC power supplying circuit 262 is connected to an alternating current (AC) power source 26. DC power is supplied to the various electronic components of the fan device by the DC power supplying circuit 262. The lamp unit 24 includes a plurality of light bulbs and a night lamp. The temperature detector 25 includes a thermistor, and generates a temperature output that varies in accordance with the ambient temperature. In this embodiment, the memory unit 27 is a programmable memory device, such as an electrically erasable programmable read only memory (EEPROM). In response to the remote-control signals received thereby, the processor unit 22 controls fan speed setting of the fan unit 23 and brightness output of the lamp unit 24 in an appropriate manner, which will be described in greater detail in the succeeding paragraphs.

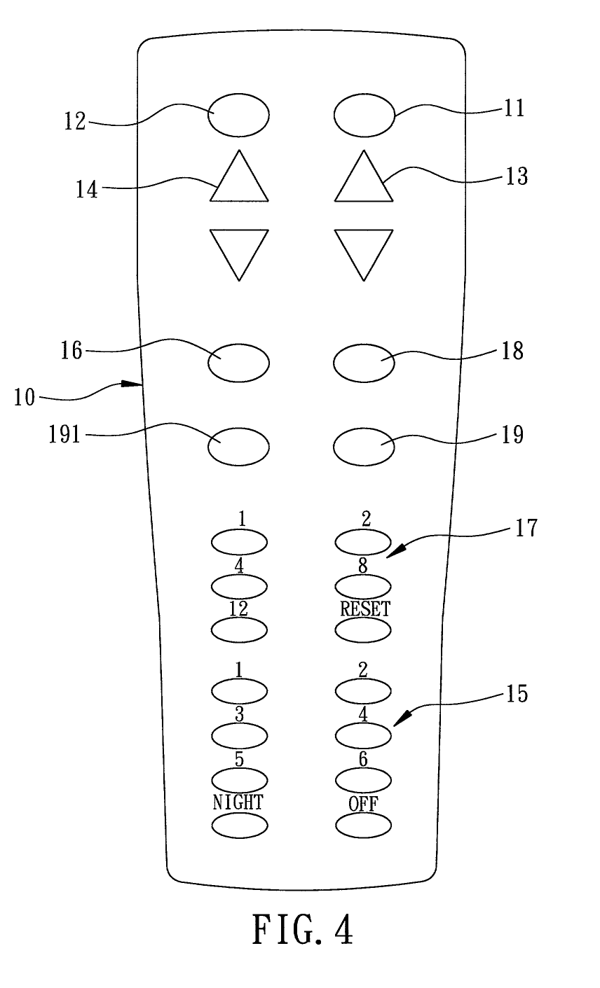

As best shown in FIG. 4, the remote controller 10 includes a fan power switch 11, a lamp power switch 12, a fan speed adjustment switch set 13, a lamp brightness adjustment switch set 14, a lamp number control switch set 15, a rotary direction control switch 16, a fan speed setting select switch set 17, a first intelligent mode control switch 18, a second intelligent mode control switch 19, and an automatic reversing mode control switch 191.

When the fan power switch 11 is operated, the remote controller 10 will generate a remote-control signal for controlling activation and deactivation of the fan unit 23 of the fan device 20 by the processor unit 22 in a conventional manner. Preferably, the fan settings prior to deactivation of the fan unit 23 are recorded by the processor unit 22 in the memory unit 27 so that the processor unit 22 can automatically select the same during subsequent activation of the fan unit 23.

When the lamp power switch 12 is operated, the remote controller 10 will generate a remote-control signal for controlling activation and deactivation of the lamp unit 24 of the fan device 20 by the processor unit 22 in a conventional manner. Preferably, the lamp settings prior to deactivation of the lamp unit 24 are recorded by the processor unit 22 in the memory unit 27 so that the processor unit 22 can automatically select the same during subsequent activation of the lamp unit 24. In addition, a 30-second delay is introduced automatically from the time the lamp power switch 12 is operated to the actual deactivation of the lamp unit 24.

The fan speed adjustment switch set 13 includes a first switch that is operated to enable the remote controller 10 to generate a remote-control signal for increasing the speed of the fan unit 23 through the control of the processor unit 22, and a second switch that is operated to enable the remote controller 10 to generate a remote-control signal for decreasing the speed of the fan unit 23 through the control of the processor unit 22. In the preferred embodiment, there are eight preset speed settings for the fan unit 23, and the switch set 13 is operated to choose any one of the preset speed settings. Preferably, a sound is generated when the highest or lowest preset speed setting is selected to alert the user.

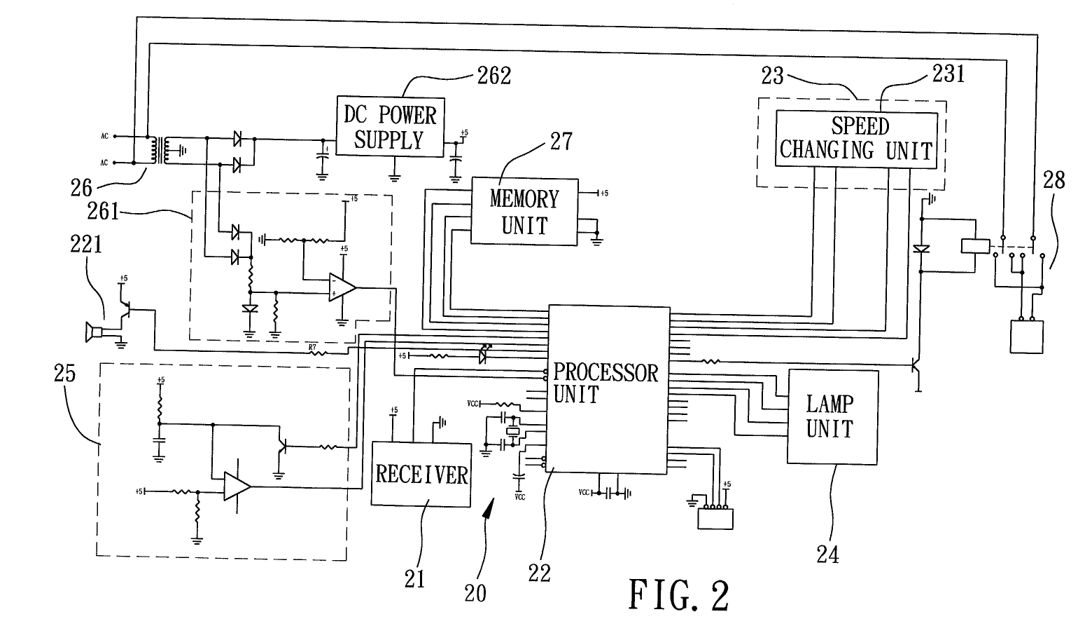

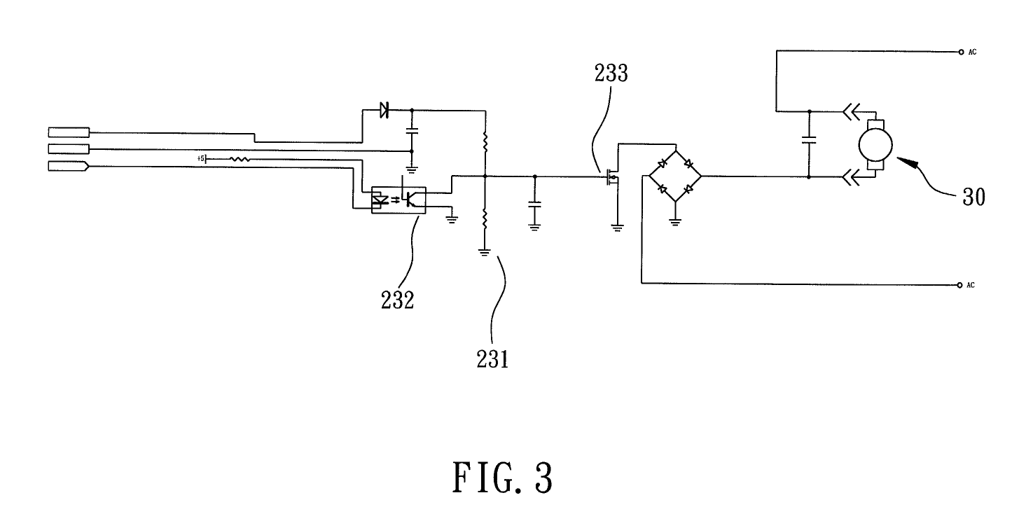

As shown in FIGS. 2 and 3, the fan unit 23 has a speed changing unit 231 which includes an optically coupled transistor 232 controlled by the processor unit 22, and a field effect transistor 233 connected to the optically coupled transistor 232 and a fan motor 30. The processor unit 22 controls the conduction time of the field effect transistor 233 via the optically coupled transistor 232 to control in turn the speed of the fan motor 30.

The lamp brightness adjustment switch set 14 includes a first switch that is operated to enable the remote controller 10 to generate a remote-control signal for increasing the brightness of the light output from the lamp unit 24 through the control of the processor unit 22, and a second switch that is operated to enable the remote controller 10 to generate a remote-control signal for dimming the brightness of the light output from the lamp unit 24 through the control of the processor unit 22. In the preferred embodiment, there are twenty preset brightness settings for the lamp unit 24, and the switch set 14 is operated to choose any one of the preset brightness settings.

The lamp number control switch set 15 is operated to enable the remote controller 10 to generate a remote-control signal for controlling the number of light bulbs of the lamp unit 24 that are to be activated by the processor unit 22. For example, operation of a second switch of the switch set 15 indicates that two light bulbs of the lamp unit 24 are to be activated by the processor unit 22. Operation of a fifth switch of the switch set 15 indicates that five light bulbs of the lamp unit 24 are to be activated by the processor unit 22. Operation of a night switch of the switch set 15 indicates that the night lamp of the lamp unit 24 is to be activated by the processor unit 22. Operation of an OFF switch of the switch set 15 indicates that the lamp unit 24 is to be deactivated by the processor unit 22.

The rotary direction control switch 16 is operated to enable the remote controller 10 to generate a remote-control signal for selecting the direction of rotation of the fan unit 23 under the control of the processor unit 22. The default direction setting of the fan unit 23 is the positive direction. When the control switch 16 is operated once, the fan motor 30 of the fan unit 23 is controlled by the processor unit 22 via a relay 28 to rotate in the negative direction. When the control switch 16 is operated for the second time, the fan motor 30 of the fan unit 23 is controlled by the processor unit 22 via the relay 28 to once again rotate in the positive direction.

The fan speed setting select switch set 17 is operated to enable the remote controller 10 to generate a remote-control signal for selecting the activation time of the fan unit 23. For example, operation of a first switch (corresponding to a one-hour setting) of the switch set 17 indicates that the fan unit 23 is to be activated by the processor unit 22 for one hour. Operation of the first switch, followed by operation of a third switch (corresponding to a four-hour setting) of the switch set 17, indicates that the fan unit 23 is to be activated by the processor unit 22 for five hours. Operation of a fourth switch (corresponding to an eight-hour setting), followed by operation of a fifth switch (corresponding to a twelve-hour setting) of the switch set 17, indicates that the fan unit 23 is to be activated by the processor unit 22 for twenty hours. The switch set 17 further includes a RESET switch which is operated when it is desired to change the activation time setting of the fan unit 23.

The first intelligent mode control switch 18 is operated to enable the remote controller 10 to generate a remote-control signal to be received by the processor unit 22 via the receiver 21 for enabling the processor unit 22 to operate in a first intelligent mode. After the user has adjusted the fan unit 23 to a desired speed setting, operation of the processor unit 22 in the first intelligent mode will enable the processor unit 22 to determine the current selected one of the preset speed settings of the fan unit 23 and to receive the temperature output of the temperature detector 25 so as to obtain a reference ambient temperature. The processor unit 22 then controls the speed changing unit 231 of the fan unit 23 to operate the fan unit 23 at another one of the preset speed settings higher than the current selected one of the preset speed settings upon detection of a predetermined increase in the current ambient temperature relative to the reference ambient temperature, and to operate the fan unit 23 at yet another one of the preset speed settings lower than the current selected one of the preset speed settings upon detection of a predetermined decrease in the current ambient temperature relative to the reference ambient temperature. As an example, for an initial ambient temperature of 28° C., the predetermined increase and the predetermined decrease are preferably set to 0.5° C.

The second intelligent mode control switch 19 is operated to enable the remote controller 10 to generate a remote-control signal to be received by the processor unit 22 via the receiver 21 for enabling the processor unit 22 to operate in a second intelligent mode. Like the first intelligent mode, after the user has adjusted the fan unit 23 to a desired speed setting, operation of the processor unit 22 in the second intelligent mode will enable the processor unit 22 to determine the current selected one of the preset speed settings of the fan unit 23 and to receive the temperature output of the temperature detector 25 so as to obtain a reference ambient temperature. The processor unit 22 then controls the speed changing unit 231 of the fan unit 23 to operate the fan unit 23 at another one of the preset speed settings higher than the current selected one of the preset speed settings upon detection of a predetermined increase in the current ambient temperature relative to the reference ambient temperature, and to operate the fan unit 23 at yet another one of the preset speed settings lower than the current selected one of the preset speed settings upon detection of a predetermined decrease in the current ambient temperature relative to the reference ambient temperature. However, unlike the first intelligent mode, for an initial ambient temperature of 28° C., the predetermined increase and the predetermined decrease in the second intelligent mode are preferably set to 0.4° C. The lower temperature gradient results in increased sensitivity that suits the larger ambient temperature range and the change in the body temperature normally experienced when the user is sleeping.

The automatic reversing mode control switch 191 is operated to enable the remote controller 10 to generate a remote-control signal to be received by the processor unit 22 via the receiver 21 for enabling the processor unit 22 to operate in an automatic reversing mode. The automatic reversing mode is selected when the ambient temperature is within a predetermined temperature range, such as 5 to 18° C., where air circulation is normally uneven. In this mode, operation of the automatic reversing mode control switch 191 enables the processor unit 22 to record the temperature output of the temperature detector 25 as a preset reversing reference temperature in the memory unit 27. Thereafter, when the processor unit 22 determines that the current ambient temperature has dropped below the preset reversing reference temperature with reference to the temperature output of the temperature detector 25, the processor unit 22 automatically controls the fan motor 30 of the fan unit 23 to rotate in the negative direction via the relay 28. The effect thereof is to improve circulation of warm air in the vicinity of the fan unit 23 so as to result in a slight increase in the detected ambient temperature. In the automatic reversing mode, the processor unit 22 further controls the fan unit 23 to resume rotation in the positive direction only upon determining that the current ambient temperature has exceeded the preset reversing reference temperature by a preset value, such as when the user activates a heating appliance.

In the preferred embodiment, whenever the processor unit 22 receives a remote-control signal from the remote controller 10 via the receiver unit 21, the processor unit 22 will activate a buzzer 221 so as to indicate the receipt of the remote-control signal to the user. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An electric fan comprising:
a fan unit;
a temperature detector for generating a temperature output that varies in accordance with the ambient temperature; and
a processor unit coupled to said fan unit and said temperature detector, said processor unit being operable so as to control said fan unit to rotate at a selected one of preset speed settings, and being further operable in an intelligent mode, wherein said processor unit determines a current selected one of the preset speed settings of said fan unit and receives the temperature output of said temperature detector so as to obtain a reference ambient temperature, wherein said processor unit controls said fan unit to operate at another one of the preset speed settings higher than the current selected one of the present speed settings upon detection of a predetermined increase in the current ambient temperature relative to the reference ambient temperature, and wherein said processor unit controls said fan unit to operate at yet another one of the preset speed settings lower than the current selected one of the present speed settings upon detection of a predetermined decrease in the current ambient temperature relative to the reference ambient temperature.

2. The electric fan as claimed in claim 1, wherein said fan unit is rotatable in positive and negative directions, and said processor unit is further operable in an automatic reversing mode, in which said processor unit controls said fan unit to rotate in the negative direction upon determining that the current ambient temperature has dropped below a preset reversing reference temperature with reference to the temperature output of said temperature detector.

3. The electric fan as claimed in claim 2, wherein, in the automatic reversing mode, said processor unit further controls said fan unit to resume rotation in the positive direction only upon determining that the current ambient temperature has exceeded the preset reversing reference temperature by a preset value.
